(19) United States
(12) Patent Application Publication
(10) Pub. No.: US 2022/0127524 A1
(43) Pub. Date: Apr. 28, 2022

(54) SALT-TOLERANT SELF-SUSPENDING PROPPANTS MADE WITH NEUTRAL STARCHES

(71) Applicant: Covia Solutions Inc., Independence, OH (US)

(72) Inventors: Gedeng RUAN, Houston, TX (US); Huaxiang YANG, Sugar Land, TX (US); Kanth JOSYULA, Sugar Land, TX (US); Vinay MEHTA, Richmond, TX (US); An Thien NGUYEN, Sugar Land, TX (US)

(73) Assignee: Covia Solutions Inc., Independence, OH (US)

(21) Appl. No.: 17/295,278

(22) PCT Filed: Nov. 19, 2019
(86) PCT No.: PCT/US2019/062090

§ 371 Date: May 19, 2021

Related U.S. Application Data
(60) Provisional application No. 62/770,625, filed on Nov. 21, 2018.

(51) Int. Cl. C09K 8/80; C09K 8/84

(52) U.S. Cl. CPC C09K 8/805; C09K 8/84

(57) ABSTRACT

A self-suspending proppant that resists the adverse effects of calcium and other cations on swelling comprises a proppant substrate particle and a gelatinized neutral starch coating on the proppant substrate particle.

### RELATED APPLICATIONS

This application claims priority to U.S. Provisional Application Ser. No. 62/770,625, filed on Nov. 21, 2018, titled SALT-TOLERANT SELF-SUSPENDING PROPPANTS MADE WITH NEUTRAL STARCHES, the entire disclosure of which is incorporated by reference herewith.

### BACKGROUND AND SUMMARY

Commonly assigned U.S. 2017/0335178 describes certain salt-tolerant self-suspending proppants in which the hydrogel polymer coating of the proppant is made from a gelatinized cationic starch. “Salt-tolerant” in this context refers to the ability of these proppants to tolerate large concentrations of calcium and other divalent cations without losing their ability to swell substantially. As described there, self-suspending proppants exhibiting a high degree of salt tolerance can be provided by forming the hydrogel polymer coating of the proppant from a gelatinized cationic starch. See, also, WO 2017/091463. The disclosures of these documents are incorporated herein by reference in their entirety.

We have now found that self-suspending proppants in which the hydrogel polymer coating is made from a gelatinized neutral starch also exhibit excellent salt tolerance as well.

Thus, this invention provides a process for fracturing a geological formation comprising pumping into the formation an aqueous fracturing fluid containing a self-suspending proppant comprising a proppant substrate particle and a coating of a hydrogel polymer on the proppant substrate particle, wherein the hydrogel polymer is a neutral starch which is at least partially gelatinized, and further wherein during the fracturing process the self-suspending proppant is exposed to water having a hardness of at least 300 ppm.

### BRIEF DESCRIPTION OF THE DRAWING

This invention may be more readily understood by reference to the following drawings wherein:

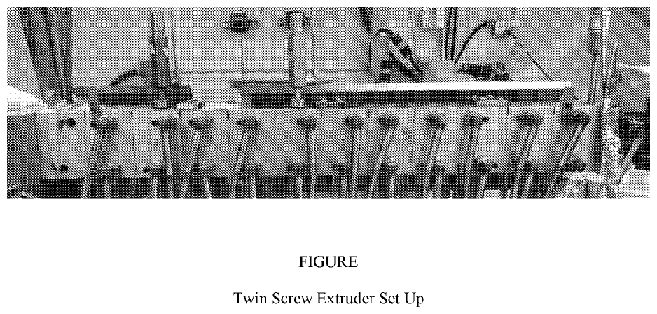

The FIG. 1s a photograph of a twin screw extruder that can be used to produce the gelatinized neutral starches used in this invention.

### DETAILED DESCRIPTION

Proppant Substrate Particle

As indicated above, the self-suspending proppants of this invention take the form of a proppant substrate particle carrying a coating of a neutral polymer.

For this purpose, any particulate solid which has previously been used or may be used in the future as a proppant in connection with the recovery of oil, natural gas and/or natural gas liquids from geological formations can be used as the proppant substrate particle of the self-suspending proppants of this invention. In this regard, see our earlier filed applications mentioned above which identify many different particulate materials which can be used for this purpose. These materials can have densities as low as ˜1.2 g/cc and as high as ˜5 g/cc and even higher, although the densities of the vast majority will range between ˜1.8 g/cc and ˜5 g/cc, such as for example ˜2.3 to ˜3.5 g/cc, ˜3.6 to ˜4.6 g/cc, and ˜4.7 g/cc and more.

Specific examples include graded sand, resin coated sand including sands coated with curable resins as well as sands coated with precured resins, bauxite, ceramic materials, resin coated ceramic materials including ceramics coated with curable resins as well as ceramic coated with precured resins, glass materials, polymeric materials, resinous materials, rubber materials, nutshells that have been chipped, ground, pulverized or crushed to a suitable size (e.g., walnut, pecan, coconut, almond, ivory nut, brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, composites formed from a binder and a filler material such as solid glass, glass microspheres, fly ash, silica, alumina, fumed carbon, carbon black, graphite, mica, boron, zirconia, talc, kaolin, titanium dioxide, calcium silicate, and the like, as well as combinations of these different materials. Especially interesting are intermediate density ceramics (densities ˜1.8-2.0 g/cc), normal frac sand (density ˜2.65 g/cc), bauxite and high density ceramics (density ˜3-5 g/cc), just to name a few. Resin-coated versions of these proppants, and in particular resin-coated conventional frac sand, are also good examples.

All of these particulate materials, as well as any other particulate material which is used as a proppant in the future, can be used as the proppant substrate particle in making the self-suspending proppants of this invention.

Hydrogel Coating

The self-suspending proppants of this invention are made in such a way that
(1) optionally and preferably, they are free-flowing when dry,
(2) they rapidly swell when contacted with their aqueous fracturing fluids,
(3) they form hydrogel coatings which are large enough to significantly increase their buoyancy during transport downhole, thereby making these proppants self-suspending during this period,
(4) these hydrogel coatings are durable enough to maintain the self-suspending character of these proppants until they reach their ultimate use locations downhole, and
(5) these hydrogel coatings are especially resistant to the adverse effects calcium and other cations can have on the swelling properties of these coatings.

In accordance with this invention, this is accomplished by (1) selecting a neutral starch as the hydrogel-forming polymer, (2) treating the neutral starch, the proppant substrate particles or both to enhance coating adhesion, (3) mixing the neutral starch with the proppant substrate particles while the starch is at least partially gelatinized thereby forming discrete starch-coated substrate particles, and then (4) drying the starch-coated substrate particles so formed.

A wide variety of different starches can be used as raw materials for making the self-suspending proppants of this invention. Examples include potato starch, wheat starch, tapioca starch, cassava starch, rice starch, corn starch, waxy corn starch, waxy wheat starch, waxy rice starch, waxy sorghum starch, waxy cassava starch, waxy barley starch, and waxy potato starch.

Starches can be either naturally-occurring or modified. In addition, modified starches can be either chemically modified, charge-modified or both. In this context, “chemically-modified” means a modification which is made to the chemistry of the starch which does not appreciably change the ability of the starch to ionize, and hence to produce net positive and/or negative charges, when the starch is dissolved or dispersed in water. Examples of chemically modified starches include alkylated starches, oxidized starches, acetylated starches, hydroxypropylated starches, monophosphorylated starches, distarch phosphate, starch acetate, octenylscuccinylated starches, bleached starches, dextrin, dextran and so forth.

Meanwhile, “charge modified” means a modification which is made to the chemistry of the starch which appreciably changes its ability to ionize, and hence to produce positive and/or negative charges, when the starch is dissolved or dispersed in water. Starches (whether naturally-occurring or chemically-modified) can be either neutral, anionic, cationic or amphoteric, depending primarily on the type and concentration of substituents present at the 2, 3, 5 and 6 positions of the monosaccharide units forming the starch molecule. Starches exhibiting net negative charges are considered to be anionic, while starches exhibiting net positive charges are considered to be cationic. Starches exhibiting both negative and positive charges are considered to be amphoteric, while starches exhibiting little or no positive or negative charges are regarded as being neutral.

“Charge-modified starches” in the context of this document refers to starches, whether naturally-occurring or chemically modified, which have been intentionally treated to introduce appreciable amounts of charge-bearing functional groups into these 2, 3, 5 and/or 6 positions, thereby appreciably changing the ability of these starches to ionize and hence produce positive and/or negative charges when dissolved or dispersed in water. See, the above-noted U.S. 2017/0335178 and WO 2017/091463, which extensively describe how to make charge-modified starches.

In accordance with this invention, the starches that are used to make the self-suspending proppants of this invention are neutral starches. That is to say, these starches contain little or no negative or positive charge-bearing functional groups. In this context, “little or no” negative or positive charge-bearing functional groups means that the concentration of these groups, i.e., the total concentration of negative groups as well as the total concentration of positive groups, as measured by the degree of substitution (“DS”) of each is less than 0.08. More typically, the degree of substitution (“DS”) of each will be less than 0.07, less than 0.06, less than 0.05, less than 0.04, less than 0.03, less than 0.02 or even less than 0.01.

Preferred starches for use in this invention are non-charge-modified, meaning they have not been modified by intentionally introducing charge-bearing functional groups into the 2, 3, 5 and/or 6 positions of the starch molecule, whether such starches are naturally-occurring or chemically-modified.

An important feature of the technologies described in the above-noted U.S. 2017/0335178 and WO 2017/091463 is that charge-modified cationic starches are used to make the hydrogel coatings of the self-suspending proppants described there. This is because, as described there, only cationic starches which contain an appreciably large concentration of cationic substitution will exhibit the level of salt tolerance desired, while only charge-modification will produce cationic starches with these appreciably large concentrations of cationic substitution as a practical matter. So, an important feature of these earlier salt-tolerant self-suspending proppants is that the cationic starches from which they are made have been intentionally charge-modified with cationic charges so that they exhibit a cationic degree of substitution (“DS”) of at least 0.09, more typically at least 0.1, at least 0.2 and even, in some instances, at least 0.4.

This invention differs from these earlier technologies in that the starches which are used to make the inventive salt-tolerant self-suspending proppants do not contain such large concentrations of cationic substitution. This is because it has been found, in accordance with this invention, that gelatinization of the starch during proppant manufacture, whether partial or total, will also achieve a significant degree of salt tolerance in the proppants obtained even if the starch used contains little or no cationic substitution.

In accordance with the invention, therefore, the concentration of cationic charge-bearing moieties in the starch which is used to make the self-suspending proppants of this invention, as measured by the degree of substitution (DS) of these moieties, is less than 0.08, more typically less than 0.07, less than 0.06, less than 0.05, less than 0.04, less than 0.03, less than 0.02 or even less than 0.01. Similarly, the concentration of anionic charge-bearing moieties in these starches, as measured by the degree of substitution (DS) of these moieties, is also less than 0.08, more typically less than 0.07, less than 0.06, less than 0.05, less than 0.04, less than 0.03, less than 0.02 or even less than 0.01.

Preferably, the starches which are used to make the self-suspending proppants of this invention are “non-charge-modified,” by which is meant that they have not been intentionally modified by introducing charge-bearing functional groups into the 2, 3, 5 and/or 6 positions of the starch molecule, whether such starches are naturally-occurring or chemically-modified.

Especially interesting of the foregoing starches are those having from about 1 to 50 wt. %, more typically about 5 to 30 wt. % or even about 10 to 25 wt. % of amylose (linear polymer) units and about 50 to 99 wt. %, more typically about 70 to 95 wt. % or even about 75 to 90 wt. % of amylopectin (branched polymer) units.

Also interesting are those starches having molecular weights of about 1 to 8 million Daltons, more typically about 2 to 6 million Daltons, although higher and lower molecular weights are still possible.

A wide variety of different commercially available neutral starches can be used for the purposes of this invention. Examples include Argo® Corn Starch, ADM® Clinton 104 Corn Starch, Clinton 106 Corn Starch, Clinton 110 Corn Starch, AYTEX® P Wheat Starch, EDIGEL 100 Wheat Starch, GEN-VIS® 700, PAYGEL® P Wheat Starch, PAYGEL® 290 Wheat Starch, Cargill Gel′ native starch, Avebe potato starch, Bene rice starch, Tate&Lyle Pearl Dent Unmodified Starch, EcoAgril Native Potato Starch, EcoAgril Native Pea Starch, EcoAgril Native Waxy Corn Starch, EcoAgril Native Wheat Starch, EcoAgril Native tapioca Starch, Superbond® T30F, Superbond® T40F, PURE-DENT® B700, Venus Maize Starch, Tereos Meritena® 100, etc.

In addition to the above neutral starches, blends of these neutral starches with other neutral hydrogel-forming polymers can also be used. For example, neutral polysaccharides other than neutral starches can be used. Examples include chitosan, cellulose, and cellulose derivatives including alkyl cellulose ethers such as methyl cellulose, ethyl cellulose and/or propyl cellulose, hydroxy cellulose ethers such as hydroxy methyl cellulose, hydroxy ethyl cellulose and/or hydroxy propyl cellulose, cellulose esters such as cellulose acetate, cellulose triacetate, cellulose propionate and/or cellulose butyrate, cellulose nitrate, cellulose sulfate and glycogen. Mixtures of these neutral polysaccharides other than neutral starches can also be used.

In addition to these neutral polysaccharides, other hydrogel polymers can also be included in the hydrogel coatings of the inventive self-suspending proppants. Examples include polyacrylamide, copolymers of acrylamide with anionic and cationic comonomers, hydrolyzed polyacrylamide, copolymers of acrylamide with hydrophobic comonomers, poly(acrylic acid), poly(acrylic acid) salts, guar gum, alginate, carrageenan, locust bean gum, carboxymethyl guar, carboxymethyl hydroxypropyl guar gum, hydrophobically associating swellable emulsion (HASE) polymers, latex and the like. Such hydrogel polymers can be anionic, cationic, amphoteric, neutral, or a mixture thereof and can be added at any time during the process of making non-extruder derived starch coated proppants. For example, these hydrogel polymers can be added along with the non-extruder derived starches of this invention just before drying or even after drying, etc.

In those instances in which neutral hydrogel-forming polymers other than neutral starches are used, at least 50 wt. % of the hydrogel-forming material used, as a whole, should be based on charge-neutral monosaccharide units. Blends in which the amount of polymerized monosaccharide units is at least 60 wt. %, at least 70 wt. %, at least 80 wt. % and even at least 90 wt. % are also contemplated.

Gelatinizing the Starch

The self-suspending proppants of this invention are made by a process in which the proppant substrate particles and the neutral starch from which these proppants are made are mixed together while the starch is at least partially gelatinized in form.

Starch molecules arrange themselves in plants in semi-crystalline granules. Heating in water causes water molecules to diffuse through these granules, causing them to become progressively hydrated and swell. In addition, their amylose content depletes through leaching out by the water. When further heated, these granules “melt” or “destructure” in the sense that their semi-crystalline structure is lost, which can be detected by a variety of different means including X-ray scattering, light-scattering, optical microscopy (birefringence using crossed polarizers), thermomechanical analysis and NMR spectroscopy, for example. This “melting”-“destructuration” effect is known as gelatinization. See, Kalia & Averous, Starchs: Biomedical and Environmental Applications, p. 89, © 2011 by Scrivener Publishing LLC, Co-published by John Wiley & Sons, Hoboken, N.J. In accordance with this invention, the neutral starch is at least partially gelatinized when it is being mixed with the proppant substrate particles.

In this regard, it is well known that the amount of water that can be taken up by starch when it gels can be many times its weight, e.g., as much as 80 times its weight. So, when we say that the neutral starch is “at least partially gelatinized,” what we mean is that the amount of water that has been taken up by the starch through gelatinization may be less than the total amount of water the neutral starch is capable of taking up through gelatinization. Indeed, in most instance of our invention, the amount of water that has been taken up by the starch through gelatinization will be less than this total. However, if desired, enough water can be used so that the maximum possible amount of water for gelatinization has been taken up by the starch.

Also, for convenience, we use the term “gelatinized starch” in this disclosure to refer both to starches which are only partially gelatinized as well as to starches which are fully gelatinized in the sense of being incapable of taking up any more water of gelatinization. Where we intend to refer to fully gelatinized starches, we use that term, i.e., “fully gelatinized starch.”

A convenient way of insuring that the desired degree of starch gelatinization is achieved is to control the water/neutral starch weight ratio of the water/starch combination. Normally, this ratio can range from about 0.05:1 to 15:1, although water/starch weight ratios of 0.5:1 to 10:1, 0.75:1 to 7.5:1, 1:1 to 5:1, 1.25:1 to 4:1, and even 1.5:1 to 3:1, are contemplated. And for this calculation, it will be understood that all of the water supplied to the starch/proppant substrate particle mixture will be taken into account including the moisture content of the neutral starch, the water content of the neutral starch paste, emulsion and/or solution if the starch is supplied in one of these forms, any make-up water that might be added, and the water content of any additives that might be used such as crosslinking agents and pretreating agents for the proppant substrate particles. In addition, if a hydrogel-forming polymer other than a neutral starch is included in the system, it will be understood that the above water/neutral starch weight ratios will be based on all of the hydrogel-forming polymer in the system, not just the neutral starch.

Also, in some embodiments of this invention, as further discussed below, it may be desirable to cause the mixture of proppant substrate particles and gelatinized neutral starch to adopt a highly viscous consistency. For this purpose, it may be desirable to limit the amount of make-up water added to this mixture, if any, such that the water/starch ratio of the mixture is 4 or less, 3 or less, 2 or less, 1 or less, or even 0.5 or less.

As indicated above, the neutral starch raw material that is used to carry out the inventive process, as received from the manufacturer, can be in a variety of different forms including a thick paste or slurry in which the starch has already been gelatinized as well as a solution, emulsion or dispersion of ungelatinized starch containing enough water for gelatinization. In these instances, adding additional make-up water for gelatinization may be unnecessary. In other instances, the neutral starch raw material as received from the manufacturer may contain little or no water such as occurs, for example, when it is in the form of an ungelatinized powder. If so, an appropriate amount of make-up water will normally be added. It will therefore be appreciated that the amount of make-up water which is added to ensure that the neutral starch is at least partially gelatinized when mixed with the proppant substrate particles will depend among other things on the nature of the neutral starch that is used to make this mixture.

Starch gelatinization normally requires that the starch-water combination have a slightly alkaline pH such as ≥7.5, ≥8, ≥9, and even ≥10. Any such pH can be used for carrying out this invention. In addition, while NaOH is most conveniently used for pH adjustment, other chemicals can also be used. In lieu of pH adjustment, other means for facilitating starch gelatinization can also be used, examples of which include enzymatic action and physical means. See, Maher, Alkali Gelatinization of Starches, Starch/Starke 35 (1983) Nr. 7, S. 226-234, © Verlag Chemie GmbH, D-6940 Weinheim 1983.

In addition to sufficient water at a suitable pH, starch gelatinization also normally requires that the starch-water combination be heated to above a characteristic temperature, known as the gelatinization temperature. See, the above-noted Kalia publication. Note, also, that this temperature can be lowered by the use of additional materials such as alcohols, sugars, organic acids, etc., which can be used in this invention, if desired. So, in carrying out this invention, heating of the neutral starch under suitable conditions to achieve at least partial starch gelatinization may be necessary, depending on the nature of the raw material starch that is being used.

For example, in those instances in which the neutral starch raw material is in the form of a thick paste or slurry in which the starch has already been gelatinized, little or no heating for effecting starch gelatinization may be necessary. On the other hand, in those instances in which the neutral starch raw material is in the form of an aqueous solution, emulsion or dispersion of ungelatinized starch or an ungelatinized starch powder, heating under appropriate conditions for effecting starch gelatinization may be necessary. It will therefore be appreciated that the amount of heating needed to effect starch gelatinization will also depend among other things on the nature of the neutral starch raw material that is used to make this mixture.

Where heating is needed for starch gelatinization, this will normally be done at moderate temperatures, e.g., 40°-100° C., although gelatinization temperatures of 45°-90° C., 50°-80° C. or even 60°-75° C., are also contemplated.

Still another way of achieving starch gelatinization is to use a heated extruder or other similar heated mixing device. In this context, a “heated extruder” will be understood to mean an extruder in which heat is supplied to the raw materials being processed by the extruder, regardless of whether the heat is supplied by the extruder itself or whether heat is supplied by heating the ingredients being processed before they are introduced into the extruder. Using heated extruders for starch gelatinization is well-known technology which has been used in the food industry for many years. See, for example, Harper, J. M. (1978). “Food extrusion”. Critical Reviews in Food Science and Nutrition 11 (2): 155-215. doi:10.1080/10408397909527262. PMID 378548. See, also, Riaz, Mian N. (2000). Extruders in Food Applications. CRC Press. p. 193. ISBN 9781566767798, as well as Akdogan, Hülya (June 1999). “High moisture food extrusion”. International Journal of food Science & Technology 34 (3): 195-207. doi:10.1046/j.1365-2621.1999.00256.x. An advantage of this approach is that, not only is this technology already well-known, but in addition less water can be used to accomplish starch gelatinization than when other types of mixing equipment are used.

For example, when a heated extruder is used, the amount of water needed to achieve starch gelatinization can be as low as 5 wt. % or even lower based on the weight of the neutral starch. In other words, the water/neutral starch weight ratio can be as low as 0.05:1 or even lower. The practical effect of this more limited amount of water as it relates to this invention is that less time, effort and expense is involved in drying the starch/proppant substrate particle mixture into free-flowing proppant as compared with using other types of equipment and approaches. Thus, it is contemplated that, when this approach is used, the water/neutral starch weight ratio will normally be 0.5:1 or less, more typically 0.3:1 or less, 0.2:1 or less, 0.1:1 or less or even 0.05:1 or less.

Mixing the Starch and Proppant Substrate Particles

As indicated above, the proppant substrate particles and the neutral starch are mixed together while the starch is at least partially gelatinized in form. For this purpose, these ingredients can be combined with one another before, during or after starch gelatinization. So, for example, if the neutral starch raw material being used is an ungelatinized powder, the proppant substrate particles, the starch powder and make-up water can be combined with one another before starch gelatinization. Continued heating and mixing will cause the starch to gelatinize and swell, thereby thickening the mixture, followed by coating of the proppant substrate particles with the gelatinized starch.

Alternatively, the starch can be heated for gelatinization before being combined with the proppant substrate particles followed by mixing for coating the gelatinized starch onto the proppant substrate particles. If so, desirably, the gelatinized starch is directly combined with the proppant substrate particles as soon as it is formed. In this context, “directly combined” means that the gelatinized starch is combined with the proppant substrate particles without allowing the starch to dry or to cool to room temperature. Preferably, combining the starch with the proppant substrate particles occurs within 30 minutes of the time when gelatinization of the neutral starch has been completed.

In the same way, if the neutral starch raw material being used is an aqueous solution, emulsion or dispersion of ungelatinized starch, it can be combined with the proppant substrate particles before the starch is gelatinized, in which case continued heating and mixing will cause starch gelatinization to occur followed by starch coating. Alternatively, the starch can be gelatinized first, after which the gelatinized starch so formed is preferably directly combined with the proppant substrate particles, followed by mixing for starch coating.

In contrast, if raw material neutral starch is already gelatinized, the starch and proppant particles, of course, will be combined after starch gelatinization has already occurred. In this case, mixing is carried out to effect coating the gelatinized starch onto the proppant substrate particles.

As indicated above, the proppant substrate particles and the gelatinized starch are mixed together in such a way that a mass of individual, discrete starch-coated proppant particles is formed. A convenient way this can be done is by formulating this mixture so that, when starch gelatinization is completed, this mixture is highly viscous in nature. By “highly viscous” we mean that the starch (plus any other hydrogel-forming polymers that may be present, if any) in this mixture has a viscosity of at least 2,000 cPs. Viscosities of at least 3,500 cPs, at least 4,000 cPs, at least 5,000 cPs, at least 7,500 cPs, and even at least 10,000 cPs are also of interest. Because of this viscosity, simple mixing causes the starch to form uniform, continuous coatings on the individual proppant substrate particles. In addition, it also causes the coated particles so formed to separate from one another into individual, discrete starch-coated particles that retain their individual, discrete nature even after mixing has stopped.

As indicated above, achieving this “highly viscous” nature can most easily be done formulating the mixture of proppant substrate particles and gelatinized starch so that its water/starch ration is 4 or less, more typically 3 or less, 2 or less, 1 or less, or even 0.5 or less. In these situations, heating the mixture to moderate temperatures (e.g., 80° C. or below) as described above, with simple continuous mixing, will normally be sufficient to cause the viscosity of the starch to increase to the desired level and hence the desired starch coating to form in a relatively short period of time, e.g., 30 minutes or less, as illustrated in the following working examples.

Another way of forming a highly viscous mixture of the gelatinized starched and proppant substrate particles is to produce the gelatinized starch in a heated extruder or other similar heated mixing device, directly combine the gelatinized starch so formed with the proppants substrate particles, and then mix the resulting mixture until starch-coated proppant substrate particles are obtained. In this context, “directly combine” has the same meaning as above.

The relative amounts of neutral starch and proppant substrate particles to use in making the self-suspending proppants of this invention depends among other things on the degree or extent to which it is desired to increase the buoyancy of the self-suspending proppants being made. One way this enhanced buoyancy can be quantified is by comparing the thickness of the hydrogel coating that is formed after the neutral starch coating has expanded through contact with an excess of water with the average diameter of the proppant particle substrate.

Another way this enhanced buoyancy can be quantified is by determining the settled bed height of the self-suspending proppant after its neutral starch coating has expanded through contact with an excess of water with the settled bed height of an equivalent amount of uncoated proppant substrate particles.

Still another way this enhanced buoyancy can be quantified is by comparing the density of the inventive self-suspending proppant when fully hydrated to the density of the proppant substrate particle from which it is made. For example, normal frac sand has a density of ˜2.65 g/cc, whereas a self-suspending proppant made from this substrate particle can have a density of 1.5 g/cc when fully hydrated, for example. This means that the hydrogel coating has been able to decrease the effective density of this self-suspending proppant by 1.15 g/cc.

In carrying out this invention, the relative amounts of neutral starch and proppant substrate particles used can vary widely, and essentially any amounts can be used. In some embodiments, the amount used will be sufficient so that the thickness of the hydrogel coating which is formed upon gelatinization is 10% to 1000% of the average diameter of the proppant particle substrate. Hydrogel coating thicknesses of 25% to 750%, 50% to 500% and 100% to 300% of the average diameter of the proppant particle substrate are contemplated.

In other embodiments, the amount of neutral starch used will be sufficient so that the settled bed height, as determined in the manner discussed more fully below, is at least 150%, more desirably, at least 175%, at least 200%, at least 250%, at least 300%, at least 350% and even at least 400% of the settled bed height of an equivalent amount of uncoated proppant substrate particles.

In yet other embodiments, the amount of neutral starch used will be sufficient so that a decrease in density of at least about 0.25 g/cc, determined as described above, is achieved. More typically, the decrease in density will be at least about 0.50 g/cc, at least about 0.75 g/cc, at least about 1.00 g/cc, at least about 1.25 g/cc, or even at least about 1.50 g/cc.

Meanwhile, the maximum amount of neutral starch that can be used will normally be limited by practical considerations in the sense that this amount is desirably not so much that no practical advantage is realized in terms of the increase in buoyancy provided by this material. This can be easily determined by routine experimentation.

So, for example, in embodiments of this invention in which normal frac sand (density 2.65 g/cc) is used as the proppant substrate particle, the amount of neutral starch used on a dry weight basis will normally be about 0.5 to 80 wt. %, more typically 1 to 50 wt %, 2 to 30 wt. %, 3 to 20 wt. %, more typically, about 4-15 wt. %, about 5-10 wt. %, or even about 6-8 wt. % based on the weight of the frac sand used. When other proppant substrate particles are used, comparable amounts of neutral starch can be used. So, for example, if an intermediate density ceramic having a density of about 1.9 g/cc is used, the amount of neutral starch used on a dry weight basis can be about 0.72 (1.9/2.65) times the above amounts on a dry weight basis if the same relative increase in buoyancy is desired. If a greater amount of buoyancy is desired, more neutral starch can be used, while if a less amount of buoyancy is desired, less neutral starch can be used, all of which can be easily determined by routine experimentation.

Chemical Modification for Enhancing Coating Adhesion

In order to improve the durability of the neutral starch coating of the self-suspending proppants of this invention once it has swollen, the neutral starch forming the coating, the proppant substrate particle, or both can be chemically treated by one or more adhesion-promoting approaches.

In accordance with one such approach, the neutral starch is crosslinked. For this purpose any di- or polyfunctional crosslinking agent having two or more functional groups capable of reacting with the pendant hydroxyl, hydroxymethyl or other electronegative groups of the neutral starch can be used. For example, organic compounds containing and/or capable of generating at least two of the following functional groups can be used: epoxy, carboxy, aldehyde, isocyanate, amide, vinyl, and allyl. Polyfunctional inorganic compounds such as borates, zirconates, silicas and their derivatives can also be used as can guar and its derivatives.

Specific examples of polyfunctional crosslinking agents that can be used in this invention include epichlorohydrin, polycarboxylic acids, carboxylic acid anhydrides such as maleic anhydride, carbodiamide, formaldehyde, glyoxal, glutaraldehyde, various diglycidyl ethers such as polypropylene glycol diglycidyl ether and ethylene glycol diglycidyl ether, other di- or polyfunctional epoxy compounds, phosphorous oxychloride, sodium trimetaphosphate and various di- or polyfunctional isocyanates such as toluene diisocyanate, methylene diphenyl diisocyanate, 1-ethyl-3-(3-dimethylaminopropyl) carbodiamide, methylene bis acrylamide, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, and diphenylmethanediisocyanates such as 2,4′-diphenylmethanediisocyanate, 4,4′-diphenylmethanediisocyanate and mixtures thereof.

The amount of such crosslinking agents that can be used can vary widely, and essentially any amount can be used. Normally, however, the amount used will be about 1 to 50 wt. %, more typically about 1 to 40 wt. %, about 3 to 40 wt. %, about 3 to 25 wt. %, about 5 to 40 wt. %, about 5 to 25 wt. %, or even about 5 to 12 wt. %, based on the dry weight of the neutral starch that is being used.

If a crosslinking agent is used, it can be added to the other ingredients at any time during preparation of the inventive self-suspending proppant. For example, it can be added as an additional ingredient to the mixture of neutral starch and proppant substrate particles, before, after or simultaneously with gelatinization. In addition, it can also be added to the proppant particle substrate particles, or the neutral starch or both, before they are combined with one another. In addition, it can also be added to the starch coated proppant particles after they have formed during the final drying and comminution step, thereby forming an outer crosslinked layer on the hydrogel polymer coating.

When a crosslinking agent is used, a catalyst for the crosslinking agent can also be included, if desired. Examples of suitable catalysts include acids, bases, amines and their derivatives, imidazoles, amides, anhydrides, and the like. These catalyst can be added together with the crosslinking agent or separately. If added separately, they can be added at any time during the preparation of the inventive self-suspending proppant, in the same way as the catalyst, as described above.

Another adhesion-promoting approach that can be used is pretreating the proppant substrate particles with a suitable adhesion promoter. For example, the proppant substrate particles can be pretreated with a silane coupling agent before it is combined with the neutral starch. The chemistry of silane coupling agents is highly developed, and those skilled in the art should have no difficulty in choosing particular silane coupling agents for use in particular embodiments of this invention.

If desired, the silane coupling agent can be a reactive silane coupling agent. As well understood in the art, reactive silane coupling agents contain a functional group capable of reacting with functional groups on the polymers to be coupled. In this invention, therefore, the particular reactive silane coupling agents used desirably contain functional groups capable of reacting with the pendant hydroxyl, hydroxy methyl or other electronegative groups of the neutral starch. Examples of such reactive silane coupling agents include vinyl silanes such as vinyl trimethoxy silanes, vinyl ethoxy silanes and other vinyl alkoxy silanes in which the alkyl group independently have from 1 to 6 carbon atoms. Other examples include reactive silane coupling agents which are based on one or more of the following reactive groups: epoxy, glycidyl/epoxy, allyl, and alkenyl.

Another type of adhesion promoter that can be used include agents which provide a wetting/binding effect on the bond between the proppant substrate particle and the neutral starch coating. Examples include reactive diluents, wax, water, surfactants, polyols such as glycerol, ethylene glycol and propylene glycol, various tackifiers such as waxes, glues, polyvinyl acetate, ethylene vinyl acetate, ethylene methacrylate, low density polyethylenes, maleic anhydride grafted polyolefins, polyacrylamide and its blends/copolymerized derivatives, and naturally occurring materials such as sugar syrups, gelatin, and the like. Nonionic surfactants, especially ethoxylated nonionic surfactants such as octylphenol ethoxylate, are especially interesting.

Still another type of adhesion promoter that can be used is the starch crosslinking agents mentioned above. In other words, one way these crosslinking agents can be used is by pretreating the proppant substrate particles with them before these particles are mixed with the neutral starch.

Drying

In accordance with this invention, the mixture of proppant substrate particles and gelatinized neutral starch as described above is dried to produce a mass of free-flowing self-suspending proppants. Drying can be done without application of heat, if desired. Normally, however, drying will be done by heating the mixture at temperatures as low as 40° C. and high as 300° C., for example. Normally, however, drying will be done at temperatures above the boiling point of water such as, for example, at >100° C. to 300° C., >100° C. to 200° C., 105° C. to 150° C., 110° C. to 140° C. or even 115° C. to 125° C. Also, in those embodiments in which the starch is heated for gelatinization in an earlier process step, as described above, drying will normally be done at drying temperatures which are higher than the gelatinization temperature by at least 20° C., more typically at least 30° C., at least 40° C., or even at least 50° C.

In some embodiments of this invention in which a crosslinking agent for the neutral starch is included in the system, the temperatures used for starch gelatinization in the mixing step described above may not be high enough to trigger the desired crosslinking reaction in any significant way. If so, the temperature at which drying of the coated proppants is carried out is preferably carried out at temperatures which are high enough to cause this crosslinking reaction to occur in a reasonable amount of time. So, for example, if an epoxy-based crosslinking agent such as polypropylene glycol diglycidyl ether is used, drying temperatures of 110° C., 120° C. or more are preferably used as they will cause crosslinking to occur within 30 minutes or so, as shown in the following working examples.

In addition, in carrying out this drying step, although the mixture being dried can be left physically undisturbed until drying is completed, it is more convenient to subject it to occasional mixing during drying, as this helps keep the individual coated proppant particles from sticking to one another, thereby minimizing particle clumping and agglomeration.

One way that drying can be done is by placing the mixture a conventional oven maintained at a desired elevated temperature. Under these conditions, drying will normally be complete in about 30 minutes to 24 hours, more typically about 45 minutes to 8 hours or even 1 to 4 hours. Moreover, by occasionally mixing the mass during this drying procedure, for example, once every 10 to 30 minutes or so, clumping/agglomeration of the coated proppant will be largely avoided, resulting in a free-flowing mass of proppants being produced.

Another convenient way of drying the mixture in accordance with this invention is by using a fluidized bed drier in which the mixture is fluidized by an upwardly flowing column of heated air. Fluidization causes individual coated proppant particles to separate from one another, which not only avoids clumping/agglomeration but also promotes rapid drying. Drying times as short as 15 minutes, 10 minutes or even 5 minutes or less are possible when fluidized bed driers are used.

As a result of the manufacturing procedure described above, a mass of individual, discrete starch-coated self-suspending proppants can be produced. Although some clumping and agglomeration might occur, these clumps and agglomerates can normally be broken up by mild agitation. In addition, even if clumping and agglomeration becomes more serious, application of moderate pressure such as occurs with a mortar and pestle will usually be sufficient to break up any agglomerates that have formed.

Properties

The self-suspending proppants of this invention, optionally but preferably, are free-flowing when dry. This means that any clumping or agglomeration that might occur when these proppants are stored for more than a few days can be broken up by moderate agitation. This property is beneficial in connection with storage and shipment of these proppants above ground, before they are combined with their aqueous fracturing fluids.

When deposited in their aqueous fracturing fluid, self-suspending proppants of this invention hydrate to achieve an effective volumetric expansion which makes them more buoyant and hence effectively self-suspending. In addition, they retain a significant portion of this enhanced buoyancy even if they are exposed to hard or salty water. Moreover, in embodiments, they are also durable in the sense that they retain a substantial degree of their self-suspending character (i.e., their enhanced buoyancy) even after being exposed to substantial shear forces.

This enhanced buoyancy can be quantitatively determined by a Settled Bed Height Analytical Test carried out in the following manner: 35 g of the proppant is mixed with 84 ml of the aqueous liquid to be tested in a glass bottle. The bottle is shaken for 1 minute, after which bottle is left to sit undisturbed for 10 minutes to allow the contents to settle. The height of the bed formed by the hydrated, expanded proppant is then measured using a digital caliper. This bed height is then divided by the height of the bed formed by the uncoated proppant substrate particle. The number obtained indicates the factor (multiple) of the volumetric expansion.

In accordance with this invention, the inventive proppants are desirably designed to exhibit a volumetric expansion, as determined by this Settled Bed Height Analytical test when carried out using a simulated hard water containing 80,000 ppm CaCO₃, of ≥˜1.3, ≥˜1.5, ≥˜1.75, ≥˜2, ≥˜2.25, ≥˜2.5, ≥˜2.75, ≥˜3, or even ≥˜3.5.

In this regard, it will be appreciated that a volumetric expansion of 2 as determined by this test roughly corresponds to cutting the effective density of the proppant in half. For example, if an inventive self-suspending proppant made from conventional frac sand exhibits a volumetric expansion of 2 according to this test, the effective density of this frac sand will have been reduced from ˜2.65 g/cc to ˜1.4 g/cc. Persons skilled in the art will immediately recognize that this significant decrease in density will have a major positive effect on the buoyancy of the proppant obtained which, in turn, helps proppant transport in hydraulic fracturing applications tremendously, avoiding any significant proppant settlement during this time.

In terms of maximum volumetric expansion, persons skilled in the art will also recognize that there is a practical maximum to the volumetric expansion the inventive proppants can achieve, which will be determined by the particular type and amount of hydrogel-forming polymer used in each application.

Another feature of the inventive proppants is that their neutral starch coatings rapidly swell when contacted with water. In this context, “rapid swelling” will be understood to mean that at least 80% of the ultimate volume increase that these coatings will exhibit is achieved within a reasonable time after these proppants have been mixed with their aqueous fracturing liquids. Normally, this will occur within 8 to 12 minutes of the proppants being combined with their aqueous fracturing liquids, although it can also occur within 30 minutes, within 20 minutes, within 10 minutes, within 5 minutes, within 2 minutes or even within 1 minute of this time.

Still another feature of the inventive proppants is durability or shear stability. In this regard, it will be appreciated that proppants inherently experience significant shear stress when they are used, not only from pumps which charge the fracturing liquids containing these proppants downhole but also from overcoming the inherent resistance to flow encountered downhole due to friction, mechanical obstruction, sudden changes in direction, etc. The hydrogel coatings of the self-suspending proppants of this invention, although inherently fragile due to their hydrogel nature, nonetheless are durable enough to resist these mechanical stresses and hence remain largely intact (or at least associated with the substrate) until they reach their ultimate use locations downhole.

For the purposes of this invention, coating durability can be measured by a Shear Analytical Test in which the settled bed height of a proppant is determined in the manner described above after a mixture of 100 g of the proppant in 1 liter of water has been subjected to shear mixing at a shear rate of about 550 s⁻¹ for a suitable period of time, for example 5 or 10 minutes. The self-suspending proppants of this invention desirably exhibit a volumetric expansion, as determined by the above Settled Bed Height Test, of ≥˜1.3, more desirably ≥˜1.5, ≥˜1.6, ≥˜1.75, ≥˜2, ≥2.25, ≥˜2.5, ≥˜2.75, ≥˜3, or even ≥˜3.5 after being subjected to the above shearing regimen for 5 minutes using ordinary tap water as the test liquid. Self-suspending proppants of this invention which exhibit volumetric expansions of ≥˜1.3, ≥˜1.5, ≥˜1.75, ≥˜2, ≥˜2.25, ≥2.5, ≥˜2.75 or even ≥˜3 after having been subjected to the above shearing regimen for 10 minutes using the simulated test waters described in Table 1 below, are especially interesting, since these test waters have been formulated with varying amounts of CaCl₂, MgCl₂, NaCl and KCl to mimic the different types of aqueous liquids normally found in hydraulic fracturing. For example, Test water 1 was formulated to simulate sea water.

In addition to the above Shear Analytical Test, another means for assessing coating durability is a Viscosity Measurement Test in which the viscosity of the supernatant liquid that is produced by the above Shear Analytical Test is measured after the proppant has had a chance to settle. If the durability of a particular proppant is insufficient, an excessive amount of its hydrogel polymer coating will come off and remain dissolved or dispersed in the supernatant liquid. The extent to which the viscosity of this liquid increases as a result of this dissolved or dispersed hydrogel polymer is a measure of the durability of the hydrogel coating. A viscosity of about 20 cPs or more indicates a low coating durability. Desirably, the viscosity of the supernatant liquid will be about 10 cPs or less, more desirably about 5 cPs or less.

Fracturing Process

As indicated above, the self-suspending proppants of this invention have been formulated to be especially resistant to the adverse effects calcium and other cations can have on the swelling properties of these proppants.

In this regard, it is well known that calcium and other cations can substantially retard the ability of anionic hydrogel-forming polymers to swell. This problem can be particularly troublesome when self-suspending proppants made with such polymers are used, because the waters to which the proppants are exposed, including both the source water from which the associated fracturing fluid is made up as well as the geological formation water which the proppants encounter downhole, can often contain significant quantities of these ions. This problem, i.e., the tendency of calcium and other cations to retard the ability of anionic hydrogel-forming polymers to swell, can begin to occur when the hardness of the water encountered by the polymer reaches levels as low as 300 ppm.

In this context, the “hardness” of a water sample means the sum of the concentrations of all divalent cations in the sample in terms of an equivalent weight of calcium carbonate. For example, a hardness of 1,000 ppm means that the total concentration of divalent cations in the sample is the same as the concentration of calcium cations that would be produced by 1,000 ppm by weight of CaCO₃ dissolved in pure water.

In many places in the United States especially where hydraulic fracturing may be practiced, municipal waters (i.e., the potable water produced by local municipalities) can have hardness levels of 300 ppm or more, while naturally-occurring ground waters can have hardness levels of 1,000 ppm or more. Meanwhile, sea water has a hardness of approximately 6,400 ppm, while the geological formation waters encountered downhole in many locations where hydraulic fracturing occurs can have hardness levels even as high as 20,000 ppm, 40,000 ppm or even 80,000 ppm.

In accordance with this invention, the self-suspending proppants of this invention, because they are made from a neutral starch which is at least partially gelatinized, substantially retain their ability to swell during hydraulic fracturing, even when exposed to waters having these hardness levels, i.e., 300 ppm or more, 500 ppm or more, 1,000 ppm or more, 6,400 ppm or more, 20,000 ppm or more, 40,000 ppm or more or even 80,000 ppm or more.

In addition, they also substantially retain their ability to swell during hydraulic fracturing, even when exposed to waters having levels of total dissolved solids (TDS) levels of 300 ppm or more, 1000 ppm or more, 30,000 ppm or more, 100,000 ppm or more, 200,000 ppm or more, or even 350,000 ppm or more.

### WORKING EXAMPLES

In order to more thoroughly describe this invention, the following working examples are provided. In these examples, self-suspending proppants made in accordance with this invention were tested for their ability to swell when exposed to different simulated test waters. Test waters (Fresh Water, TW1 and TW2) were formulated with varying amounts of CaCl₂), MgCl₂, NaCl, Na₂SO₄ and KCl to mimic the different types of aqueous liquid normally found in hydraulic fracturing. Test water 1 was formulated to simulate sea water. The properties of these test waters are set forth in the following Table 1:

TABLE 1
Properties of Test Waters (TW)

| | Properties of Each Test Water | | |
|---|---|---|---|
| Property | Fresh Water | TW 1 | TW 2 |
| pH | 6.5 | 5.8 | 6.2 |
| Conductivity, μS | 295 | 19,200 | 501,000 |
| Hardness, ppm | 120 | 6,400 | 40,000 |
| TDS*, ppm | <1,000 | 29,600 | 350,000 |

*Total Dissolved Solids

Twin Screw Extrusion Process

The FIGURE shows one example of twin screw extruder setup, which has 12 heating barrels/zones and a Die. Corn starch was feeding from Zone 1 into the twin screw extruder at 25 lbs per hr, 6 wt % NaOH solution was injected at Zone 3 into the extruder at 33 lbs per hr, and water was injected at Zone 6 into the extruder at 24 lbs per hr. Table 2 listed different loading levels of NaOH and water as an example. The extrudate will be collected for certain amount of time and directly used for the subsequent coating process.

TABLE 2
Different loading levels of NaOH and Water

| Sample No. | Corn Starch | NaOH | Water |
|---|---|---|---|
| Extrudate-1 | 25.53 | 2.69 | 42 |
| Extrudate-2 | 22.53 | 1.89 | 53.48 |

### Example 1 Coating of Extrudate on to Sand

1000 g of sand was preheated at 350° F. and added into a mixing bowl of a commercial Kitchen Aid mixer. Then certain amount of extrudate was added onto the sand, mix at speed 4 for 0.5 min. Planned amount of 1.25 wt % PEGDGE (polyethylene glycol diglycidyl ether) solution was then added subsequently and mixed at speed 4 for 1-4 min. After mixing, the mixture was dried in a commercial available fluid bed dry at 100° C. and 60 rpm for 1-8 min. Coated samples and their performance testing are listed in Table 3. In this table, the degree of swelling exhibited by each proppant was determined by a bottle shaking test in which 35 g of the dried sample was mixed with 84 mL of the particular test water used in a glass bottle. The bottle was shaken for 1 min and allowed to settle for 5 min. In some cases, this procedure was repeated a second time. The height of the swollen proppant obtained was then compared with the height of 35 g of a dried sand sample containing no polymer coating to determine the percentage by which the height of the starch-coated polymer had increased.

TABLE 3
Composition and Swelling Ability of Proppants

| | | | | 1^{st} Shaking | | | 2^{nd} | 1^{st} | 2^{nd} |
|---|---|---|---|---|---|---|---|---|---|
| | | | Crosslinker | Swelling in | 2^{nd} Shaking | 1^{st} Shaking | Shaking | Shaking | Shaking |
| | Extru | Dry Load | (% Based on | Fresh | Swelling in | Swelling in | Swelling | Swelling | Swelling |
| Samp | date | (%, BOS) | Starch) | Water | Fresh Water | TW1 | in TW1 | in TW2 | in TW2 |
| S-0 | E-1 | 8.51 | 0.24 | — | — | 160 | 180 | 95 | 130 |
| S-1 | E-1 | 7.17 | 0.26 | — | — | 145 | 150 | 105 | 130 |
| S-2 | E-2 | 3.18 | 0.23 | 75 | 90 | 90 | 90 | 65 | 65 |
| S-3 | E-2 | 5.51 | 0.31 | 100 | 95 | 130 | 135 | 100 | 110 |
| S-4 | E-2 | 7.59 | 0.25 | 165 | 80 | 150 | 160 | 115 | 135 |

### Example 2 Coating of Extrudate and Hydrogel Polymer on to Sand

Self-suspending proppants containing different amounts of hydrogel polymer were produced using the method described in Example 1 and then observed visually to determine their settling times. These results, which are set forth in Table 4, show that coatings made from the neutral starches of this invention can give final products with a slow settling rate.

TABLE 4
Hydrogel Polymer Impact on Settling Rate

| | | TW1 | | | | TW2 | | | |
|---|---|---|---|---|---|---|---|---|---|
| | | 1st | | 2nd | | 1st | | 2nd | |
| | Hydrogel | Shanking | Settling | Shanking | Settling | Shanking | Settling | Shanking | Settling |
| | Polymer | Swelling | Time | Swelling | Time | Swelling | Time | Swelling | Time |
| Sample | (% BOS) | (%) | (sec) | (%) | (sec) | (%) | (sec) | (%) | (sec) |
| 0802-1 | 0 | 125 | 3.5 | 135 | 3.5 | 95 | 4 | 105 | 5 |
| 0802-1C | 0.5 | 130 | 4 | 130 | 5 | 95 | 7 | 100 | 8 |
| 0802-1B | 1 | 125 | 5 | 125 | 7 | 95 | 9 | 95 | 12 |
| 0802-1A | 1.5 | 120 | 6 | 120 | 11 | 90 | 10 | 90 | 18 |
| 0802-1D | 2 | 125 | 8 | 120 | 16 | 95 | 15 | 95 | 27 |

Although only a few embodiments of this invention have been described above, it should be appreciated that many modifications can be made with departing from the spirit and scope of this invention. All such modifications are intended to be included within the scope of this invention, which is to be limited only by the following claims.

1. A process for fracturing a geological formation comprising pumping into the formation an aqueous fracturing fluid containing a self-suspending proppant comprising a proppant substrate particle and a coating of a hydrogel polymer on the proppant substrate particle, wherein the hydrogel polymer is a neutral starch which is at least partially gelatinized, and further wherein during the fracturing process the self-suspending proppant is exposed to water having a hardness of at least 300 ppm.

2. The process of claim 1, wherein during the fracturing process the self-suspending proppant is exposed to water having a hardness of at least 1,000 ppm.

3. The process of claim 2, wherein during the fracturing process the self-suspending proppant is exposed to water having a hardness of at least 6,400 ppm.

4. The process of claim 3, wherein during the fracturing process the self-suspending proppant is exposed to water having a hardness of at least 20,000 ppm.

5. The process of claim 4, wherein the self-suspending proppant comes into contact with water having a hardness of at least 40,000 ppm.

6. The process of claim 1, wherein the self-suspending proppant has been made by mixing proppant substrate particles with a neutral starch which is at least partially gelatinized thereby forming discrete starch-coated substrate particles, and then drying the starch-coated substrate particles so formed,

7. The process of claim 1, wherein during manufacture of the self-suspending proppant
(a) the proppant substrate particle is treated with an adhesion promoter,
(b) the neutral starch is crosslinked, or
(c) both.

8. The process of claim 7, wherein the neutral starch contains about 5 to 30 wt. % of amylose units and about 70 to 95 wt. % of amylopectin.

9. The process of claim 1, wherein the self-suspending proppant exhibits a volumetric expansion by a factor of ≥˜1.3 when exposed to a simulated hard water containing 80,000 ppm CaCO₃.

10. The process of claim 8, wherein the self-suspending proppant exhibits a volumetric expansion by a factor of ≥˜11.35 when exposed to a simulated hard water containing 80,000 ppm CaCO₃.

11. The process of claim 1, wherein the total concentration of negative groups as well as the total concentration of positive groups in the neutral starch hydrogel polymer, as measured by the degree of substitution (“DS”) of each, is less than less than 0.08.

12. The process of claim 11, wherein the total concentration of negative groups as well as the total concentration of positive groups in the neutral starch hydrogel polymer, as measured by the degree of substitution (“DS”) of each, is less than less than 0.05.
